(19) United States
(12) Patent Application Publication
(10) Pub. No.: US 2025/0335135 A1
(43) Pub. Date: Oct. 30, 2025

(54) PRINTING SYSTEM, PRINTING METHOD THEREOF, STORAGE MEDIUM, AND SERVER SYSTEM

(71) Applicant: CANON KABUSHIKI KAISHA, Tokyo (JP)

(72) Inventor: Shun Nakamura, Kanagawa (JP)

(21) Appl. No.: 19/185,331

(22) Filed: Apr. 22, 2025

(30) Foreign Application Priority Data
Apr. 30, 2024 (JP) 2024-074041

(51) Int. Cl. G06F 3/12

(52) U.S. Cl. CPC G06F 3/122; G06F 3/1247; G06F 3/1267

(57) ABSTRACT

A server includes an obtaining unit configured to obtain, from an information processing apparatus, data to be printed, an identifying unit configured to identify one or more formats based on device information of the one or more image forming apparatuses, a converting unit configured to convert the data into the one or more formats, and a holding unit configured to hold the data converted into the one or more formats,. At least one image forming apparatus of the one or more image forming apparatuses includes a receiving unit configured to receive, from the server, the data of at least one format from among the data of the one or more formats held by the server, and a printing unit configured to print the received data.

### BACKGROUND OF THE INVENTION

### Field of the Invention

The present invention relates to a printing system, a printing method thereof, a storage medium, and a server system.

### Description of the Related Art

Hold printing developed for practical application includes not immediately printing a print job received by a printing server from an information processing terminal and the printing server transmitting the print job in response to a request from an image forming apparatus. The data format able to be printed by the image forming apparatus may vary depending on the image forming apparatus. Japanese Patent Laid-Open No. 2013-242848 proposes that print data is converted in advance into a data format determined based on attribute information (country, region, affiliation, position) of the user who input a print job into the printing server, and data of this data format is transmitted in response to a request from an image forming apparatus. By converting the data format in advance in this manner, the processing time when executing printing in hold printing is reduced. The data format determined based on the attribute information of the user who input the print job may not always be able to be printed by the image forming apparatus actually instructed to print. In this case, conversion to a data format that can be printed by the image forming apparatus needs to be performed again, meaning that the processing time when executing printing cannot be reduced.

### SUMMARY OF THE INVENTION

An aspect of the present invention enables the realization of technology for converting data into a format printable by an image forming apparatus that executes printing. According to some embodiments, a printing system comprising a server and one or more image forming apparatuses, wherein the server includes an obtaining unit configured to obtain, from an information processing apparatus, data to be printed, an identifying unit configured to identify one or more formats based on device information of the one or more image forming apparatuses, a converting unit configured to convert the data into the one or more formats, and a holding unit configured to hold the data converted into the one or more formats, and at least one image forming apparatus of the one or more image forming apparatuses includes a receiving unit configured to receive, from the server, the data of at least one format from among the data of the one or more formats held by the server, and a printing unit configured to print the received data is provided.

Further features of the present invention will become apparent from the following description of exemplary embodiments with reference to the attached drawings.

### BRIEF DESCRIPTION OF THE DRAWINGS

FIG. 1 is a block diagram for describing an example of the configuration of a printing system according to a first embodiment.

FIGS. 2A to 2C are block diagrams for describing an example of the hardware configuration of each apparatus in the first embodiment.

FIG. 3 is a block diagram for describing an example of the software configuration of an image forming apparatus according to the first embodiment.

FIG. 4 is a block diagram for describing an example of the software configuration of a printing server according to the first embodiment.

FIG. 5 is a block diagram for describing an example of the software configuration of an information processing terminal according to the first embodiment.

FIG. 6 is a sequence diagram for describing an example of a license registration method according to the first embodiment.

FIG. 7 is a schematic view for describing an example of a license registration screen according to the first embodiment.

FIGS. 8A to 8C are diagrams for describing examples of device information according to the first embodiment.

FIG. 9 is a sequence diagram for describing an example of an application installation method according to the first embodiment.

FIG. 10 is a schematic view for describing an example of an authentication screen according to the first embodiment.

FIG. 11 is a schematic view for describing an example of a portal screen according to the first embodiment.

FIG. 12 is a schematic view for describing an example of a portal screen according to the first embodiment.

FIG. 13 is a schematic view for describing an example of a portal screen according to the first embodiment.

FIG. 14 is a schematic view for describing an example of a portal screen according to the first embodiment.

FIG. 15 is a schematic view for describing an example of a screen for using an application according to the first embodiment.

FIG. 16 is a flow diagram for describing an example of a print data conversion method according to the first embodiment.

FIG. 17 is a sequence diagram for describing an example of a print data printing method according to the first embodiment.

FIGS. 18A and 18B are schematic views for describing examples of a login screen according to the first embodiment.

FIGS. 19A and 19B are schematic views for describing examples of a print screen according to the first embodiment.

FIG. 20 is a schematic view for describing an example of a portal screen according to a second embodiment.

FIG. 21 is a diagram for describing an example of use settings according to the second embodiment.

FIG. 22 is a flow diagram for describing an example of a method for when an image forming apparatus is added according to a modified example.

FIG. 23 is a schematic view for describing an example of a screen for deleting an image forming apparatus according to a modified example.

FIG. 24 is a flow diagram for describing an example of a method for when an image forming apparatus is deleted according to a modified example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### FIRST EMBODIMENT

### Printing System Configuration Example

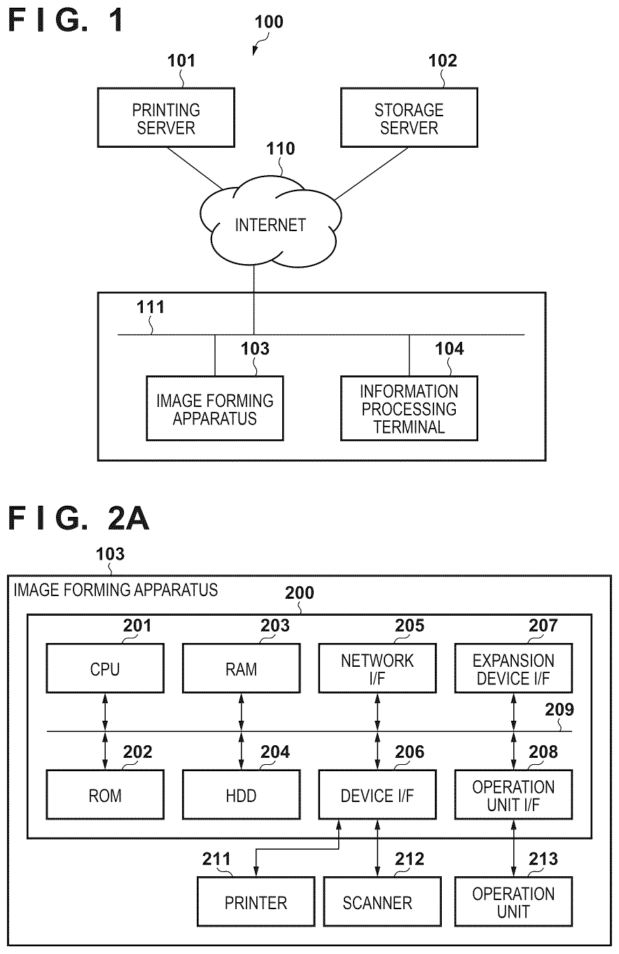

An example of the configuration of a printing system 100 according to the first embodiment will be described with reference to FIG. 1. The printing system 100 includes a printing server 101, an image forming apparatus 103, and an information processing terminal 104. The printing system 100 may also include a storage server 102. Alternatively, the storage server 102 may be treated as an apparatus external to the printing system 100. Also, the information processing terminal 104 may be treated as an apparatus external to the printing system 100.

In the example of FIG. 1, the printing system 100 includes one of each of the printing server 101, the image forming apparatus 103, and the information processing terminal 104. Alternatively, the printing system 100 may include a plurality of printing servers 101, a plurality of image forming apparatuses 103, and/or a plurality of information processing terminals 104. A system configured to one or more servers is referred to as a server system. Specifically, a printing server system includes one printing server 101 or a plurality of printing servers 101.

The printing server 101 and the storage server 102 are each connected to the Internet 110. The image forming apparatus 103 and the information processing terminal 104 are each connected to the Internet 110 via a local area network (LAN) 111. The LAN 111 is a network within a company office, for example. In the example of FIG. 1, the image forming apparatus 103 and the information processing terminal 104 are connected to the same LAN 111. Alternatively, the image forming apparatus 103 and the information processing terminal 104 may be connected to different LANs 111.

The printing server 101 provides a web portal to a client (for example, the information processing terminal 104) and in particular provides a service relating to printing (for example, a printing service). The printing server 101 may be a server hosted on a cloud platform. In this case, the printing server 101 may be referred to as a cloud printing server, and the printing service may be referred to as a cloud printing service.

The storage server 102 provides a storage service (for example, a filing service) to the client (for example, the printing server 101, the image forming apparatus 103, and the information processing terminal 104). The storage server 102 may be a server hosted on a cloud platform. In this case, the storage server 102 may be referred to as a cloud storage server, and the storage service may be referred to as a cloud storage service.

The image forming apparatus 103 forms images according to instructions. The formed images may be two-dimensional or may be three-dimensional. The image forming apparatus 103 may be a digital multi-function peripheral provided with a plurality of main functions such as a copy function, a scan function, a print function, and a FAX function. Alternatively, the image forming apparatus 103 may be a dedicated device with a single main function (for example, a print function). The image forming apparatus 103 can communicate with the printing server 101 and the storage server 102 via the LAN 111 and the Internet 110.

The information processing terminal 104 is used to input print jobs to the printing server 101 and the image forming apparatus 103, for example. The information processing terminal 104 may be an information processing apparatus such as a personal computer (PC), a smartphone, or a tablet. The information processing terminal 104 can communicate with the printing server 101 and the storage server 102 via the LAN 111 and the Internet 110.

### Image Forming Apparatus Hardware Configuration Example

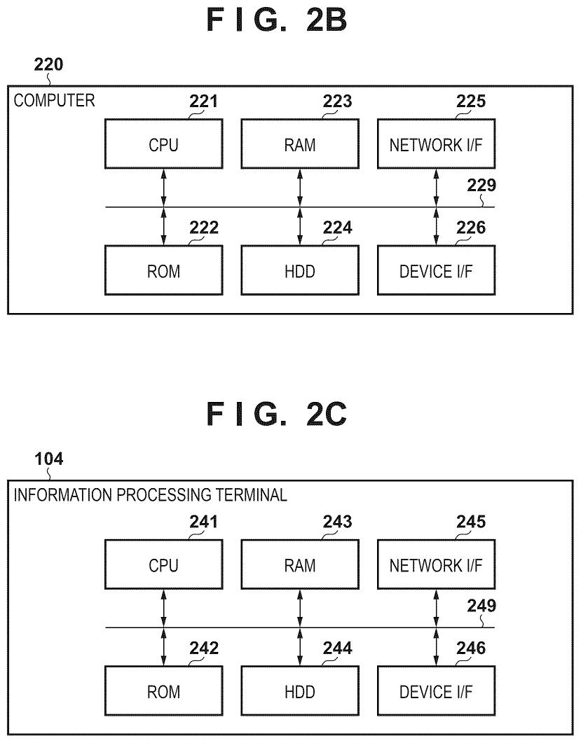

An example of the hardware configuration of the image forming apparatus 103 will now be described with reference to FIG. 2A. In the example illustrated in FIG. 2A described below, the image forming apparatus 103 is a digital multi-function peripheral. The image forming apparatus 103 includes the components illustrated in FIG. 2A. The image forming apparatus 103 may not include a portion of the components illustrated in FIG. 2A and may include other components. The description above applies to the image forming apparatus 103 as well as the hardware configuration examples of other apparatuses described below.

A central processing unit (CPU) 201 is a control program executor built into the image forming apparatus 103. The CPU 201 is configured of one or more processors. The CPU 201 controls the operations of the devices connected to a controller unit 200 via each I/F and storage medium memory. Read-only memory (ROM) 202 is a non-volatile memory that stores a system boot program, a system program, and an application program. Random-access memory (RAM) 203 is a volatile memory that stores an operating system, system software, application software, and similar programs and data when these are executed.

A hard disk drive (HDD) 204 is a storage apparatus with a large capacity compared to the RAM 203. The HDD 204 stores an operating system, system software, application software, image data, settings data, print jobs, user information, and the like. Also, the HDD 204 may store information used in the operations of the image forming apparatus 103 such as fonts and the like. By the CPU 201 executing a program stored in the ROM 202, the program stored in the HDD 204 is loaded onto the RAM 203. Thereafter, the CPU 201 executes the program loaded onto the RAM 203 and processes the data stored in the RAM 203, the ROM 202, and the HDD 204. In this manner, the operations of the image forming apparatus 103 are executed.

In a case where the image forming apparatus 103 is a small multi-function peripheral, the image forming apparatus 103 may not include a HDD 204, and the system software, application software, and the like may be stored in the ROM 202. Instead of the HDD 204, a solid state disk (SSD), a flash memory, or a similar storage apparatus may be used.

A network interface (I/F) 205 is connected to the network and communicates with external devices on the network. A device I/F 206 connects devices (in the example of FIG. 2A, a printer 211 and a scanner 212) that input and output images to a controller unit 210. The controller unit 210 performs input and output of image data with the printer 211 and the scanner 212 via the device I/F 206. The CPU 201 reads document images by controlling the scanner 212. Image data representing a read document image is input to the controller unit 210 via the device I/F 206 and stored in the RAM 203 or the HDD 204. Image processing is executed on the stored image data as necessary using an application program loaded onto the RAM 203. Also, the image data is output to the printer 211 via the device I/F 206, and the CPU 201 prints the image data onto a sheet by controlling the printer 211.

An expansion device I/F 207 is a universal serial bus (USB) (registered trademark) port or a Bluetooth (registered trademark) or similar wireless transceiver that enables any optional apparatuses to connect. Via the expansion device I/F 207, an optional apparatus such as an ID card reader or a biometric authentication apparatus can connect, for example.

An operation unit I/F 208 is an interface that controls the input and output relating to an operation unit 213 including a touch panel. The CPU 201 outputs image data to be displayed on the operation unit 213 to the operation unit 213 via the operation unit I/F 208. Also, the CPU 201 receives input information obtained by the user operating the operation unit 213 from the operation unit 213 via the operation unit I/F 208. Each component included in the controller unit 210 is connected to one another via a bus 209.

The image forming apparatus 103 may be a printer that does not include the scanner 212, for example. Also, in a case where the image forming apparatus 103 is a multi-function peripheral including a FAX function, the controller unit 210 may include a modem apparatus I/F (not illustrated) and may be able to transmit faxes by connecting to a public line via a modem apparatus.

### Computer Hardware Configuration Example

An example of the hardware configuration of a computer 220 will now be described with reference to FIG. 2B. The computer 220 may be used as the printing server 101 or may be used as the storage server 102. Each server may be configured by one computer 220 or may be configured by a plurality of the computers 220. The components of the computer 220 are connected to one another via a bus 229.

A CPU 221 controls the overall operations of the computer 220 by reading out a control program stored in a ROM 222 or a HDD 224 onto a RAM 223 and executing various types of processing. The RAM 223 is a memory used as a temporary storage area such as a main memory of the CPU 221, a working area, and the like. The HDD 224 is a large-capacity storage apparatus that stores image data and various programs. A network I/F 225 is an interface for connecting to the network. A device I/F 226 is an interface for connecting to input devices (for example, a keyboard and the like) and output devices (for example, a display and the like). In a case where the computer 220 provides an interface for the user via a network I/F, the computer 220 may not include the device I/F 226.

### Information Processing Terminal Hardware Configuration Example

An example of the hardware configuration of the information processing terminal 104 will now be described with reference to FIG. 2C. The components of the information processing terminal 104 are connected to one another via a bus 249.

A CPU 241 controls the overall operations of the information processing terminal 104 by reading out a control program stored in a ROM 242 or a HDD 244 and executing various types of processing. A RAM 243 is a memory used as a temporary storage area such as a main memory of the CPU 241, a working area, and the like. The HDD 244 is a large-capacity storage apparatus that stores image data and various programs. A network I/F 245 is an interface for connecting to the network. A device I/F 246 is an interface for connecting to input devices (for example, a keyboard and the like) and output devices (for example, a display and the like). Input devices and output devices may be integrated into the information processing terminal 104.

### Image Forming Apparatus Software Configuration Example

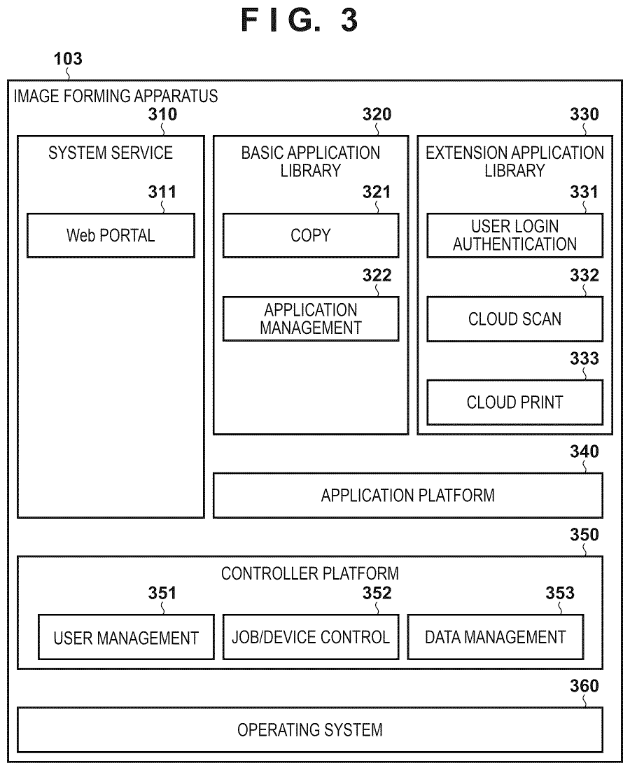

An example of the software configuration of the image forming apparatus 103 will now be described with reference to FIG. 3. The software of the image forming apparatus 103 is executed by the CPU 201 of the image forming apparatus 103. The image forming apparatus 103 may not include a portion of the components illustrated in FIG. 3 and may include other components. At least a portion of the functions implemented by the software may be executed by a dedicated circuit such as an application specific integrated circuit (ASIC). The description above applies to the image forming apparatus 103 as well as the software configuration examples of other apparatuses described below.

An operating system 360 provides various types of resource management services and frameworks optimized for control of the installed system for the software running thereon. Specifically, the various types of resource management services and frameworks include multitask management of essentially running a plurality of processes in parallel by managing a plurality of execution contexts of processing by the CPU 201 and task-to-task communication for implementing synchronization and data exchange between tasks. Also, the operating system 360 provides a protocol stack implemented with various types of protocol processes such as memory management, interrupt management, various types of device drivers, local interface, and network and communications.

A controller platform 350 includes a user management module 351, a job/device control module 352, and a data management module 353. The user management module 351 provides an application with a mechanism for managing the information (for example, authentication information) of a local user in the image forming apparatus 103 using the RAM 203 or the HDD 204. A login application can implement user login control for the image forming apparatus 103 using the authentication information of a local user managed by the user management module 351. The job/device control module 352 executes image forming jobs such as scanning, printing, and copying by controlling the printer 211 and the scanner 212 in accordance with an instruction from an application. Also, the job/device control module 352 manages the status of devices such as the printer 211 and the scanner 212, errors, and the like.

The data management module 353 manages image and various types of settings data used when executing an image forming job. Also, the data management module 353 manages job execution history and counter information, various types of data controlled by applications, and device information of the image forming apparatus 103. The device information may include configuration information relating to the configuration of the image forming apparatus 103 and capability information relating to the capability of the image forming apparatus 103.

A system service 310 is a software module that manages program updates of the controller platform 350 and the operating system 360, device information, network settings, and the like. Also, the system service 310 configures a web portal 311. The web portal 311 can be interacted with from a remote terminal (for example, the information processing terminal 104).

An application platform 340 is middleware that can be used from the various types of applications. Specifically, the application platform 340 enables the mechanisms of the operating system 360 and the controller platform 350 from the various types of application in a basic application library 320 and an extension application library 330 described below.

The basic application library 320 is an application group that provides the basic functions of the image forming apparatus 103. This application group is stored in the ROM 202 or the HDD 204 from an initial state when the image forming apparatus 103 is shipped, and the extension application library 330 is a discretionary application group separately installed and run to expand the functions that the image forming apparatus 103 implements. Each application is displayed on the screen of the operation unit 213, and the various types of functions are implemented in accordance with a user operation received by the operation unit 213.

In the example of FIG. 3, the basic application library 320 includes copy 321 and application management 322. The copy 321 is an application for executing a copy job of scanning a document and printing on a sheet. The application management 322 is an application for managing the installation and uninstallation of extension applications in the extension application library 330.

In the example of FIG. 3, the extension application library 330 is installed with user login authentication 331, cloud scan 332, and cloud print 333 as extension applications.

The user login authentication 331 is an application that displays a screen for inputting user authentication information on the operation unit 213 and implements user login processing for the image forming apparatus 103 using the user authentication information input to the operation unit 213. The user login authentication 331 may implement the user login processing using user authentication information read from an ID card reader or a biometric authentication apparatus connect via the expansion device I/F 207 instead of the user authentication information input to the operation unit 213. The user login authentication 331 may communicate with the printing server 101 via the network I/F 205 and compare the user authentication information managed on the printing server 101 and the user authentication information input at the image forming apparatus 103 to perform user authentication. The user login authentication 331 may perform user authentication by comparing the input user authentication information and user authentication information managed by the user management module 351.

The cloud scan 332 is an application that transmits an image file generated by a document being scanned by the image forming apparatus 103 to the storage server 102. The cloud print 333 is an application that prints image data for printing received from the printing server 101 using the image forming apparatus 103. The cloud print 333 may print image data for printing received from the storage server 102 using the image forming apparatus 103. The cloud print 333 transmits the printing execution result to the printing server 101.

### Printing Server Software Configuration Example

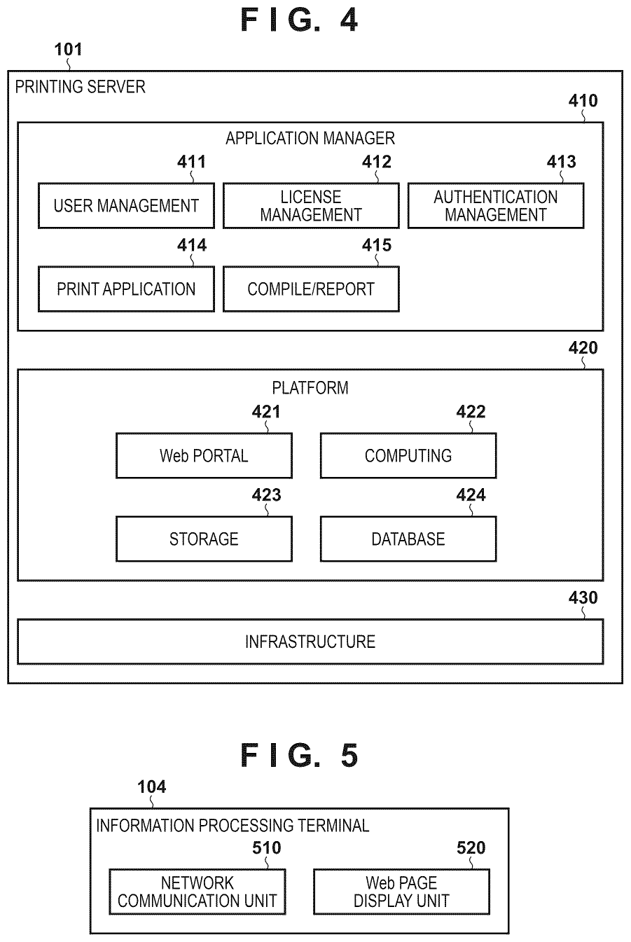

An example of the software configuration of the printing server 101 will now be described with reference to FIG. 4. In the example of FIG. 4 described below, the printing server 101 is hosted on a cloud platform. In other cases also, the printing server 101 has similar functions.

An infrastructure 430 is a base for the printing server 101 to provide the various types of service. The infrastructure 430 includes a virtual machine, storage, a network, and an operating system.

A platform 420 is a framework for providing common basic functions to an application manager 410 using the infrastructure 430. The platform 420 includes web portal 421, computing 422, storage 423, and database 424.

The application manager 410 indicates the various types of application groups running on the platform 420. The application manager 410 includes user management 411, license management 412, authentication management 413, print application 414, and compile/report 415.

The user management 411 centrally manages the user information on the printing server 101. The registration and deletion of users may be performed from the control panel of the image forming apparatus 103. The user management 411 manages the target user information using the database 424. Also, the user management 411 may be a web application that provides an application programming interface (API) for receiving user authentication instructions from the user login authentication 331 running on the image forming apparatus 103.

The license management 412 is a web application that provides a web service screen for centrally managing each application on the printing server 101 using the web portal 421. Via the web service screen, the user can install an application to be managed, register a license, and uninstall. Also, the license management 412 may be a web application that provides an API for receiving a license registration instruction from the user login authentication 331 or the application management 322 running on the image forming apparatus 103. In a case where a license registration instructed by the application management 322 of the image forming apparatus 103 is successful, the license management 412 obtains a printing service use application running on the image forming apparatus 103 from the storage 423 and provides it to the image forming apparatus 103.

The authentication management 413 is a web application that provides a web service screen for setting the user login authentication method using the web portal 421. On the web service screen, settings for the user login authentication methods for each application centrally managed on the printing server 101 are set. The authentication management 413 manages the target user login authentication method using the storage 423 or the database 424. Also, the authentication management 413 is a web application that provides an API for receiving an instruction requesting settings information from the user login authentication 331 running on the image forming apparatus 103. Also, the authentication management 413 is involved with access to various types of web service screens provided by the application manager 410 and user authentication when there is an API call.

The user management 411, the license management 412, and the authentication management 413 executed on the printing server 101 and the user login authentication 331 executed on the image forming apparatus 103 can operate in cooperation. Accordingly, the centrally managed user authentication method and the authentication information can be used to log into the image forming apparatus 103.

The print application 414 is a web application that provides an API for receiving an instruction requesting the document to be printed and an instruction to execute printing from the cloud print 333 executed on the image forming apparatus 103 using the web portal 421. The print application 414, in response to receiving the instruction requesting the document to be printed, replies with a list of documents to be printed that exist in the target storage. Also, the print application 414, in response to receiving an instruction to execute printing, uses the computing 422 to convert the data to be printed into a data format printable by the image forming apparatus 103. Also, the print application 414 may be a web application that provides an API for receiving a print job to be transmitted via email of the information processing terminal 104 and an API for receiving an instruction requesting to print the job from the cloud print 333.

The print application 414 of the printing server 101 and the cloud print 333 of the image forming apparatus 103 can operate in cooperation. Accordingly, with the image forming apparatus 103, the user can execute the same print workflow as the printing server 101.

The compile/report 415 is a web application that provides an API for receiving a job execution result to be transmitted from the cloud scan 332 and the cloud print 333 of the image forming apparatus 103 using the web portal 421. Also, the compile/report 415 may be a web application that uses the computing 422 to compile the received job execution results and provides a web service screen for displaying the compilation result.

The web service screen and the API provided by the application manager 410 are managed separately on a tenant basis, and a different URL for each tenant is generated, for example. Also, the data managed by the application manager 410 is managed separately on a tenant basis. A tenant may refer to a unit of management in the printing system 100, and a tenant may be configured on a company basis or a company organization basis, for example.

### Information Processing Terminal Software Configuration

FIG. 5 is a block diagram illustrating the software configuration of the information processing terminal 104 according to the present embodiment. A program running on the information processing terminal 104 includes a network communication unit 510 and a web page display unit 520. The network communication unit 510 is a module for connecting to the LAN 111 and communicating with the printing server 101. The web page display unit 520 displays a web service screen provided by the printing server 101 and obtains a user operation on the screen. The web page display unit 520 may be a web browser.

### Method of Registering Image Forming Apparatus in Printing Server

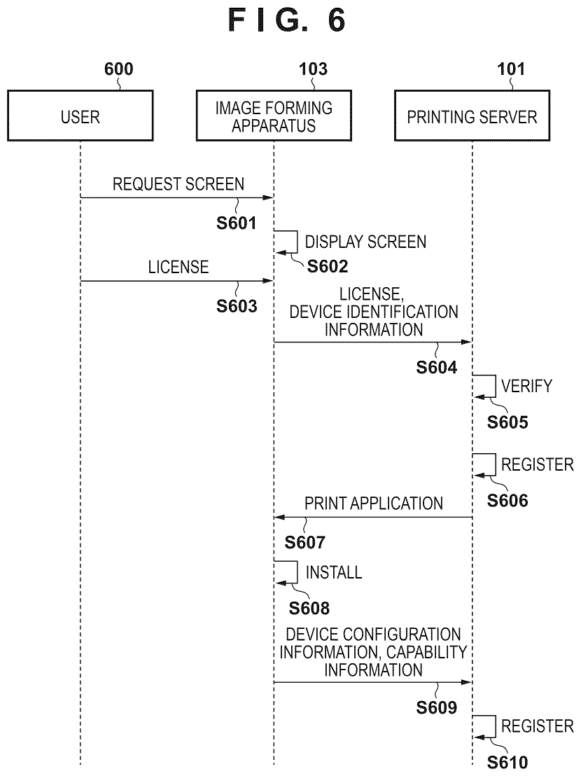

A method of registering the image forming apparatus 103 in the printing server 101 and installing an application for using the printing server 101 on the printing server 101 will now be described with reference to FIG. 6. The processing of the image forming apparatus 103 is implemented by a program stored in the ROM 202 being read out to the RAM 203 and executed by the CPU 201. In a similar manner, the processing of the printing server 101 is implemented by a program stored in the ROM 222 being read out to the RAM 223 and executed by the CPU 221. The method of FIG. 6 is started in response to a user 600 (for example, an administrator) of the image forming apparatus 103 using the operation unit 213 to issue an instruction to display a screen for registering a use license of the printing server 101.

In step S601, the application management 322 of the image forming apparatus 103 obtains an instruction to display a screen for registering a use license of the printing server 101 from the user 600 of the image forming apparatus 103 via the operation unit 213. The screen for registering a use license of the printing server 101 is referred to as a license registration screen. In step S602, the application management 322 displays the license registration screen on the operation unit 213.

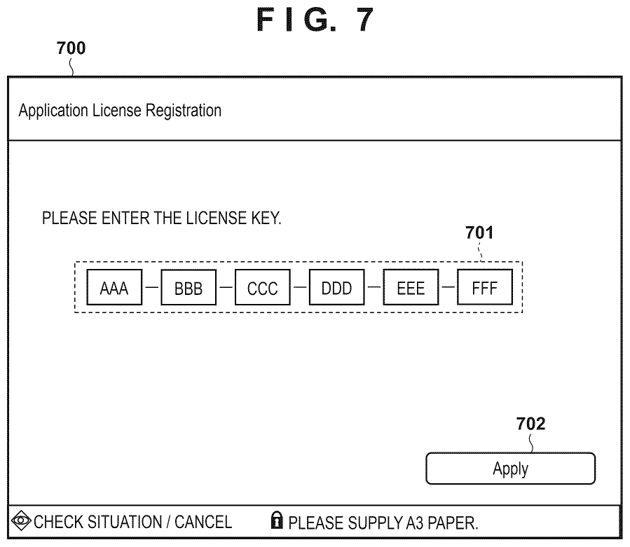

An example of a license registration screen 700 will now be described with reference to FIG. 7. The license registration screen 700 includes a license key input field 701 and an apply button 702. The user 600 inputs a license key for expanding the functions of the image forming apparatus 103 obtained in advance in the license key input field 701 of the license registration screen 700 and presses the apply button 702. In step S603, the application management 322, in response to the apply button 702 being pressed, obtains the license key input into the license key input field 701.

In step S604, the application management 322 transmits the license key obtained in step S603 and the device identification information of the image forming apparatus 103 to the printing server 101. The device identification information of the image forming apparatus 103 is information for the printing server 101 to uniquely identify the image forming apparatus 103 and is stored in advance in the ROM 202, for example. The device identification information is a serial number, for example. The address of the printing server 101 is also stored in advance in the HDD 204, for example.

In step S605, the license management 412 of the printing server 101 verifies the license key received in step S604. In example of FIG. 6 described below, the license key is determined to be valid.

In step S606, the license management 412 registers the image forming apparatus 103 identified by the device identification information received in step S604 in the database 424 as a device that can use the printing server 101. The license management 412 may register the image forming apparatus 103 in association with a specific tenant. The license management 412 may identify the tenant associated with the image forming apparatus 103 is any manner. For example, the license management 412 may associate together a specific tenant and a license key when the license key is issued and may identify the tenant based on the license key obtained in step S604. Alternatively, the license management 412, in step S604, may further obtain a tenant ID of the tenant using the image forming apparatus 103 from the image forming apparatus 103.

In step S607, the license management 412 transmits an application for using the printing server 101 to the image forming apparatus 103. In step S608, the application management 322 installs the received application on the image forming apparatus 103. Via this processing, the cloud print 333 can be used in the image forming apparatus 103.

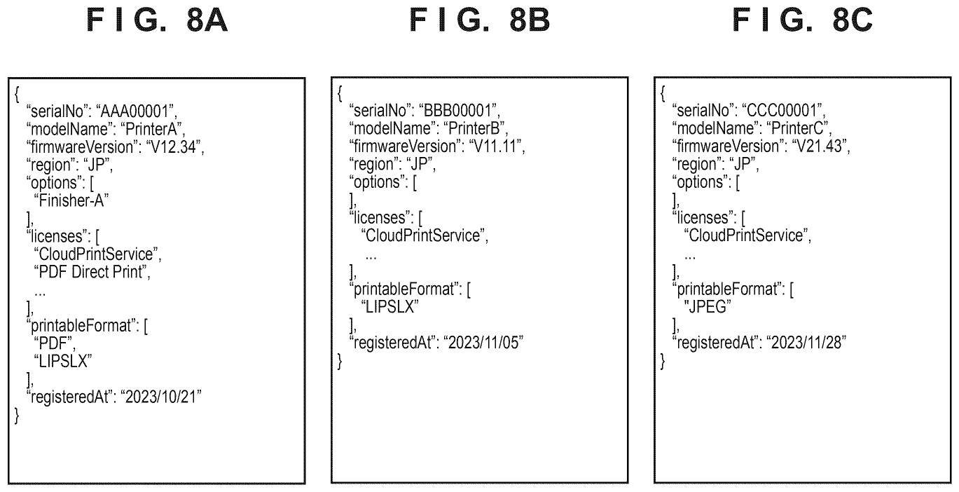

In step S609, the cloud print 333 obtains device configuration information of the image forming apparatus 103 from the data management module 353 and transmits this to the printing server 101. Various examples of device information will now be described with reference to FIGS. 8A to 8C. “serialNo” indicates the serial number. As described above, the serial number is an example of a device identification information. “modelNam” indicates the model type. “firmware Version” indicates the firmware version. “region” indicates the dispatch country. “licenses” indicate a list of registered licenses. “printableFormat” indicates the printable data format. The printable data format may be represented as a page description language. “registeredAt” indicates the registration date and time. Of these items, “serialNo”, “modelNam”, “firmware Version”, “region”, “licenses”, and “registeredAt” may be classified as configuration information. “printableFormat” may be classified as device information.

In step S610, the print application 414 registers the device information received from the image forming apparatus 103 in association with the image forming apparatus 103. Specifically, the print application 414 identifies one image forming apparatus 103, from among the one or more image forming apparatuses 103 registered in the database 424, with the “serialNo” of the received configuration information. The print application 414 stores the device information associated with this image forming apparatus 103 in the database 424.

Via the operations described above, the image forming apparatus 103 is registered in the printing server 101 as a device that can be used by the printing server 101.

### Method of Installing Application in Information Processing Terminal

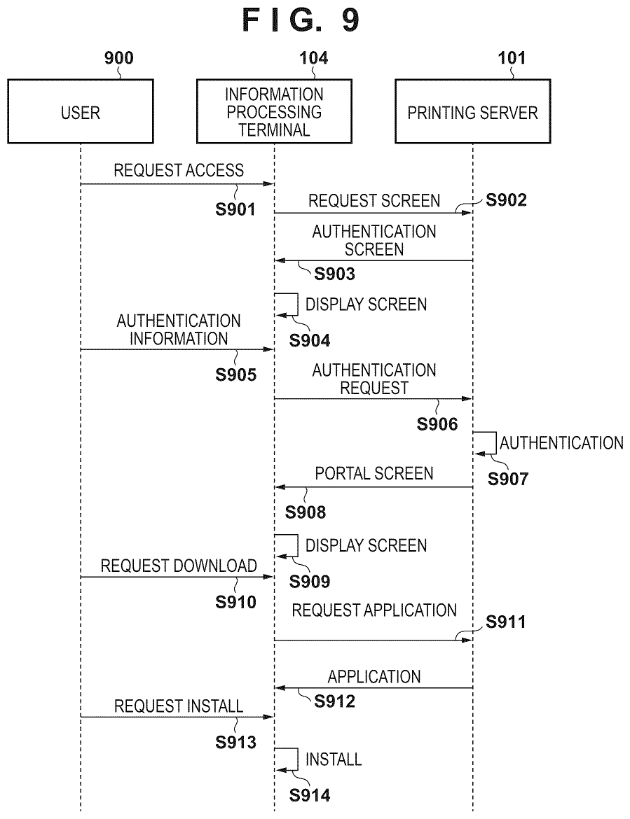

A method of accessing the web portal 421 of the printing server 101 from the information processing terminal 104 and installing an application for using the printing server 101 on the information processing terminal 104 will now be described with reference to FIG. 9. The processing of the information processing terminal 104 is implemented by a program stored in the ROM 242 being read out to the RAM 243 and executed by the CPU 241. In a similar manner, the processing of the printing server 101 is implemented by a program stored in the ROM 222 being read out to the RAM 223 and executed by the CPU 221. The method of FIG. 9 is started in response to a user 900 of the information processing terminal 104 using an operation unit connected to the device I/F 246 to issue an instruction to access the web portal 421.

In step S901, the web page display unit 520 of the information processing terminal 104 obtains the instruction to access the web portal 421 from the user 900 via the operation unit. In step S902, the web page display unit 520 makes a request to the printing server 101 for the screen of the web portal 421 via the network communication unit 510 in response to the instruction obtained in step S901. In step S903, the web portal 421 of the printing server 101 transmits an authentication screen for logging into the web portal 421 to the information processing terminal 104 in response to the request of step S902. In step S904, the web page display unit 520 displays the screen received from the printing server 101 on the operation unit.

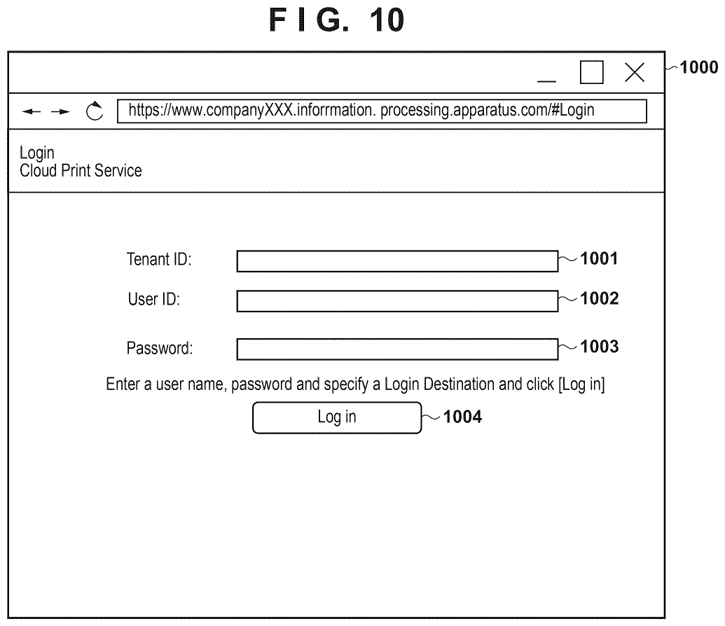

An example of an authentication screen 1000 for logging into the web portal 421 will now be described with reference to FIG. 10. The authentication screen 1000 includes an input field 1001 for inputting a tenant ID, an input field 1002 for inputting a user ID, and an input field 1003 for inputting a password. The authentication screen 1000 further includes a confirm button 1004 for obtaining the login instruction. The user 900 inputs the requested information in the input fields 1001 to 1003 and presses the confirm button 1004.

In step S905, the web page display unit 520, in response to the confirm button 1004 being pressed, obtains the information input into the input fields 1001 to 1003. This information may be referred to as authentication information for use in user authentication. In step S906, the web page display unit 520 transmits an authentication request including the authentication information obtained in step S905 to the printing server 101.

In step S907, the authentication management 413 of the printing server 101 verifies the authentication information received in step S906. In the example of FIG. 9, it is assumed that the verification is successful. In step S908, the web portal 421 transmits the screen of the web portal 421 to the information processing terminal 104. This screen is referred to as a portal screen. In step S909, the web page display unit 520 displays the portal screen received in step S908 on the operation unit.

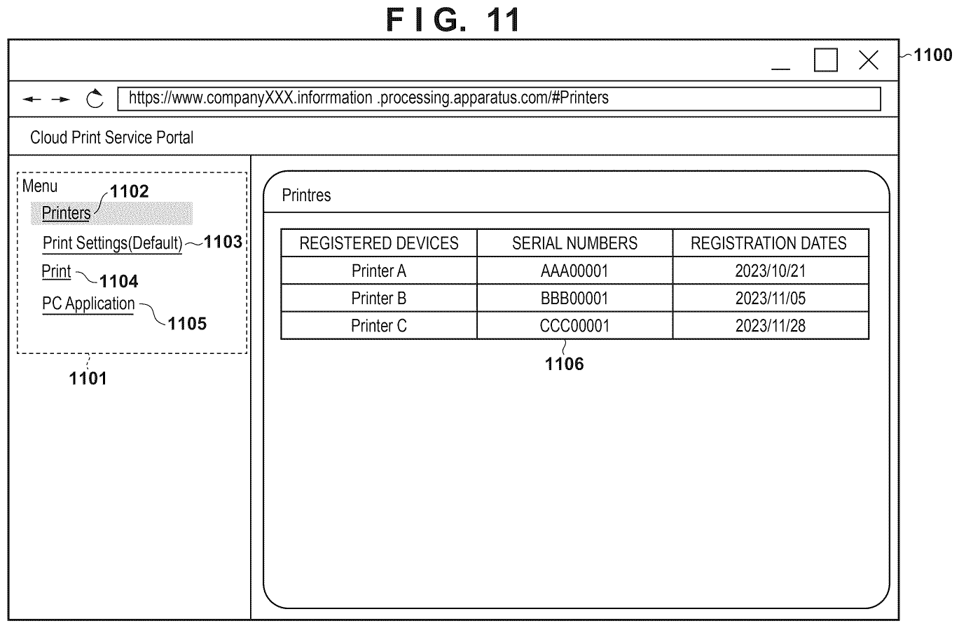

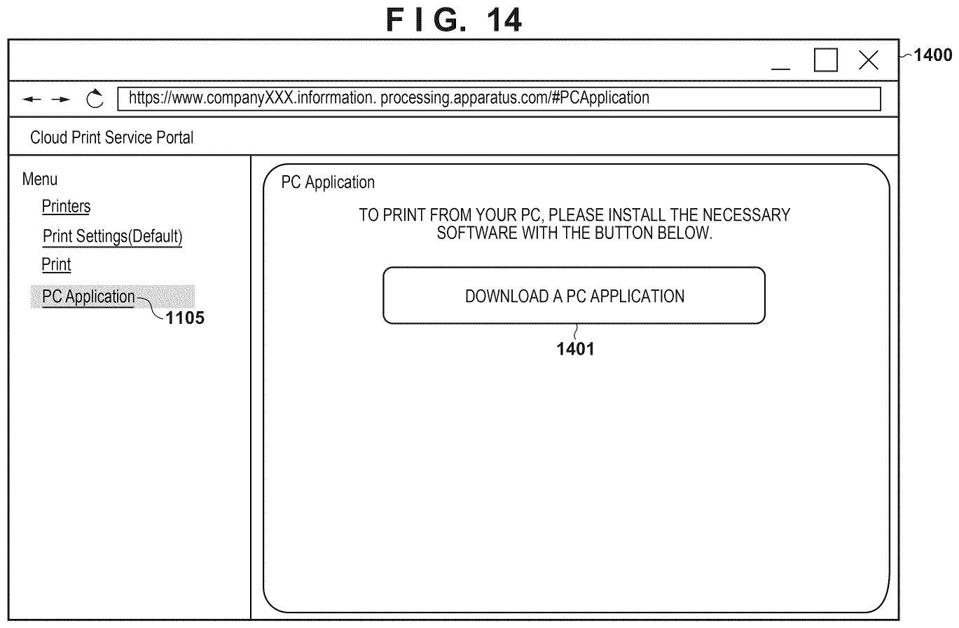

Examples of the portal screen will now be described with reference to FIGS. 11 and 14. A portal screen 1100 of FIG. 11 is a screen displayed when a list menu 1102 is selected from a menu 1101. The portal screen 1100 includes a registered printer list 1106. The registered printer list 1106 displays a list of image forming apparatuses registered to the tenant that the user 900 authenticated in step S907 belongs to and information of each image forming apparatuses. In the example of FIG. 11, as the image forming apparatus information, model name, serial number, and registration date is displayed. Alternatively or in addition, as the image forming apparatus information, device information may be displayed.

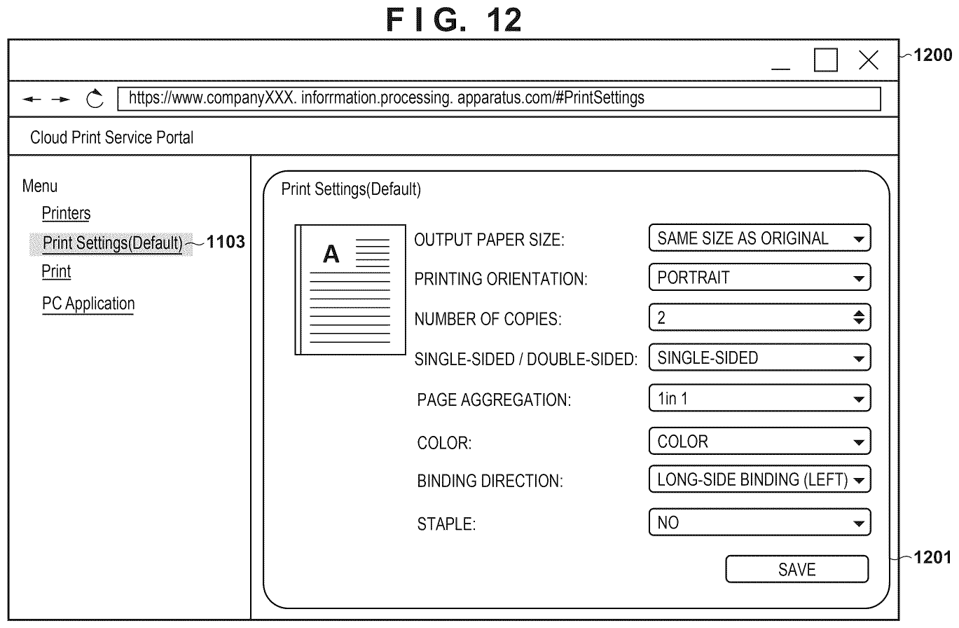

A portal screen 1200 of FIG. 12 is a screen displayed when a settings menu 1103 of the menu 1101 is selected. The portal screen 1200 includes a field 1201 including pull-down menus for designating the default print settings and a button for a save instruction. The user 900 can change the print settings.

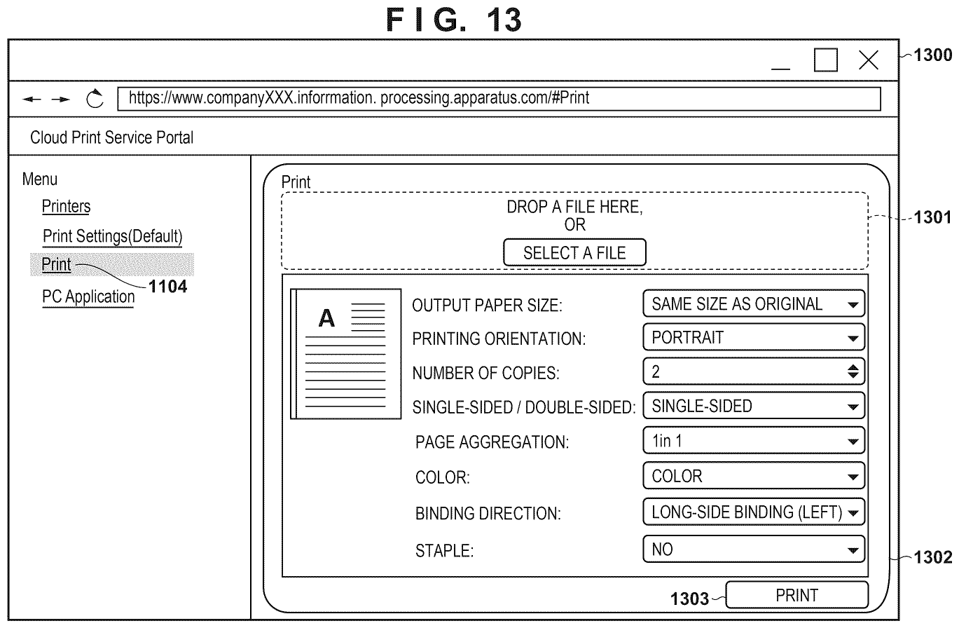

A portal screen 1300 of FIG. 13 is a screen displayed when a print menu 1104 is selected from the menu 1101. The portal screen 1300 includes a field 1301 for designating the data to be printed, a field 1302 for designating the print settings, and a button 1303 for an execute print instruction.

A portal screen 1400 of FIG. 14 is a screen displayed when an application settings menu 1105 is selected from the menu 1101. The portal screen 1400 includes a button 1401 for instructing the download of an application provided by the printing server 101. By such an application being installed, the information processing terminal 104 can transmit a printing instruction for a software (for example, document software, spreadsheet software, and the like) file of the information processing terminal 104 to the printing server 101.

Returning to the description of FIG. 9, in step S910, the web page display unit 520 detects the press of the button 1401 of the portal screen 1400 by the user 900. In step S911, the web page display unit 520 makes a request to the printing server 101 for an application in response to the press of the button 1401. In step S912, the web portal 421 reads out the application stored in the storage 423 and transmits this to the information processing terminal 104. The web portal 421 notifies the user 900 that reception of the application is complete.

In step S913, the web page display unit 520 detects an instruction to install the application from the user 900. In step S914, the web page display unit 520 installs the application received in step S912.

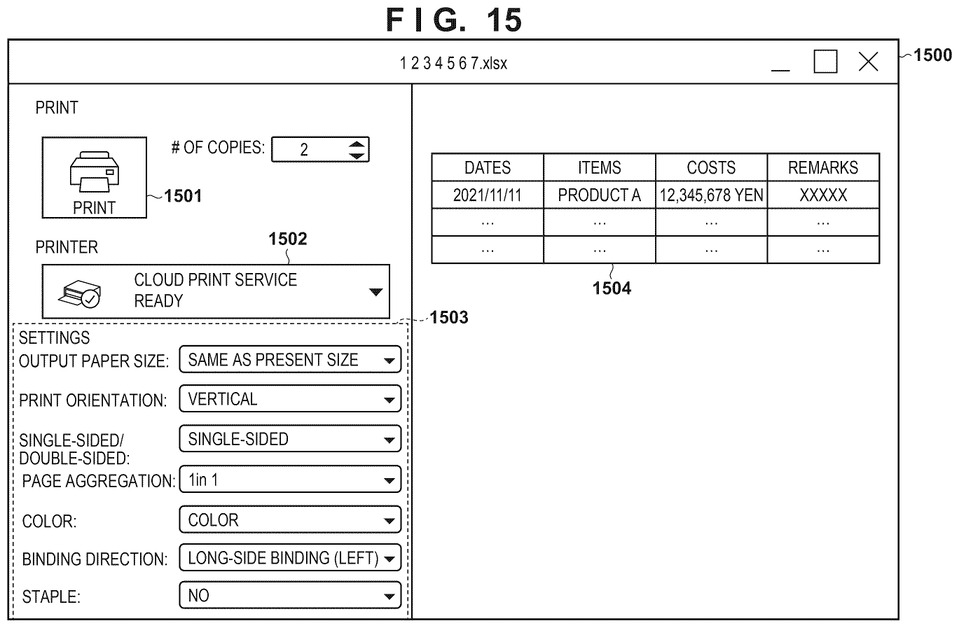

An example of a screen 1500 for using the application installed in step S914 will now be described with reference to FIG. 15. The screen 1500 is a screen for instructing the printing server 101 to print the file opened in the spreadsheet software installed on the information processing terminal 104. The screen 1500 includes a button 1501 for a print instruction, a list 1502 for designating the image forming apparatus to execute printing, a field 1503 for designating the print settings, and a preview display 1504. In step S914, since the application is installed, in the list 1502, “Cloud Printing Service” for instructing the printing server 101 to print is selectable. In response to the button 1501 being pressed by the user 900, the information processing terminal 104 instructs the printing server 101 to print the target data using the settings designated in the field 1503.

### Method of Print Data Conversion by Printing Server

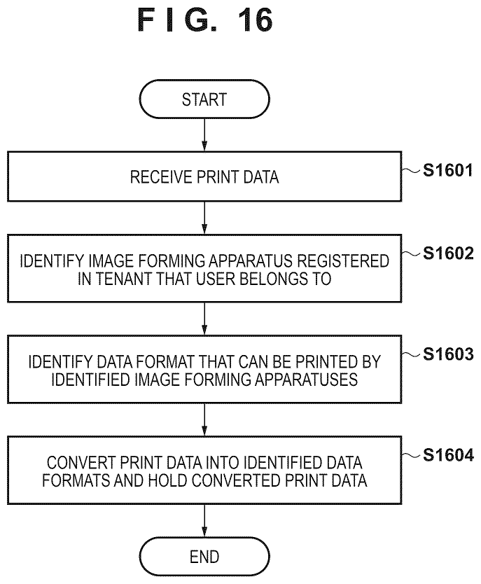

A method of converting print data for transmission to the image forming apparatus 103 by the printing server 101 will now be described with reference to FIG. 16. The processing of the printing server 101 is implemented by a program stored in the ROM 222 being read out to the RAM 223 and executed by the CPU 221. The method of FIG. 16 is started in response to the information processing terminal 104 transmitting a printing instruction to the printing server 101. The printing instruction is performed by the button 1303 of the portal screen 1300 and the button 1501 of the screen 1500, for example. The user designates the data to be printed and the settings for printing the data in the printing instruction. The data to be printed is represented as print data. The settings for printing are represented as print settings. In the example described below, the user 900 who installed the application in the information processing terminal 104 in the processing of FIG. 9 issues a printing instruction. Alternatively, the application installation and the printing instruction may be performed by different users.

In step S1601, the print application 414 of the printing server 101 receives a printing instruction from the information processing terminal 104. The printing server 101 processes the print data as hold printing. In other words, the printing server 101 holds the print data until an additional instruction is received from the user 900 and transmits the print data to the image forming apparatus 103 in response to the additional instruction being received from the user 900. In this example, the printing server 101 obtains the print data from the information processing terminal 104. Alternatively, the printing server 101 may obtain the setting for the storage destination of the print data from the information processing terminal 104 and may obtain the print data from an information processing apparatus (for example, the storage server 102) different from the information processing terminal 104.

In step S1602, the print application 414 identifies the image forming apparatus 103 registered in the tenant that the user 900 who issued the printing instruction belongs to. First, the print application 414 identifies the tenant that the user 900 belongs to. The print application 414 may obtain a tenant ID input to the input field 1001 of the authentication screen 1000 from the information processing terminal 104. Alternatively, the printing server 101 may store the user ID of the user and the tenant ID of the tenant that the user belongs to together in association and may identify the tenant ID based on the user ID obtained from the information processing terminal 104. Alternatively, the printing server 101 may query a different server in which the user ID of the user and the tenant ID of the tenant that the user belongs to are stored together in association for the tenant ID. Thereafter, the print application 414 references the database 424 and identifies the one or more image forming apparatuses 103 registered in association with the tenant ID. The one or more image forming apparatuses 103 registered in association with the specific tenant may match the one or more image forming apparatuses 103 included in the registered printer list 1106 of the portal screen 1100.

In step S1603, the print application 414 references the device information of each image forming apparatus 103 registered in the database 424 and identifies a data format for which printing is possible by at least one of the one or more image forming apparatuses 103 identified in step S1602. The identified data format may be managed in a list. The list is represented as a data format list.

As described above, the printing server 101 obtains the device information from the image forming apparatuses 103 via the messages illustrated in FIGS. 8A to 8C and manages the device information of each image forming apparatus 103. The image forming apparatus 103 (serial number “AAA00001”) with the device information of FIG. 8A can execute printing in the data formats of “PDF” and “LIPSLX”. The image forming apparatus 103 (serial number “BBB00001”) with the device information of FIG. 8B can execute printing in the data format of “LIPSLX”. The image forming apparatus 103 (serial number “CCC00001”) with the device information of FIG. 8C can execute printing in the data format of “JPEG”. Accordingly, for the tenants of the three registered image forming apparatuses 103, the set of data formats “PDF”, “LIPSLX”, and “JPEG” is identified in step S1603.

In step S1604, the print application 414 converts the print data received in step S1601 into the one or more data formats identified in step S1603 and holds the converted print data. For example, the print application 414 stores the converted print data in the storage 423. In the example described above, the print data is converted into “PDF”, “LIPSLX”, and “JPEG”. The print application 414 may stores the converted print data in association with the user 900 (specifically, the user ID) who issued the printing instruction.

### A Method of Printing Print Data of Printing Server with Image Forming Apparatus

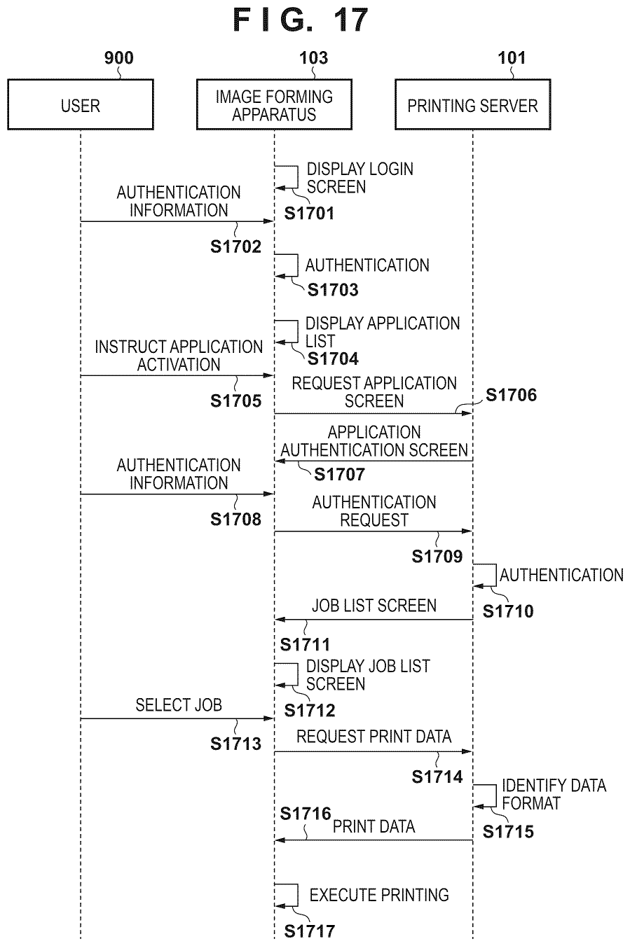

A method of printing the print data stored in the printing server 101 with the image forming apparatus 103 will now be described with reference to FIG. 17. The processing of the image forming apparatus 103 is implemented by a program stored in the ROM 202 being read out to the RAM 203 and executed by the CPU 201. In a similar manner, the processing of the printing server 101 is implemented by a program stored in the ROM 222 being read out to the RAM 223 and executed by the CPU 221. At the point in time when the method of FIG. 17 is executed, the method of FIG. 16 has ended and the converted print data is stored in the printing server 101. The method of FIG. 17 is started in response to the user 900 operating (for example, touching) the operation unit 213 of the image forming apparatus 103. In the example described below, the user 900 who issued the printing instruction in the processing of FIG. 16 operates the image forming apparatus 103 as illustrated in FIG. 17. The method of FIG. 17 may be executable by all of the one or more image forming apparatuses 103 included in the printing system 100 or may be executable by only a portion.

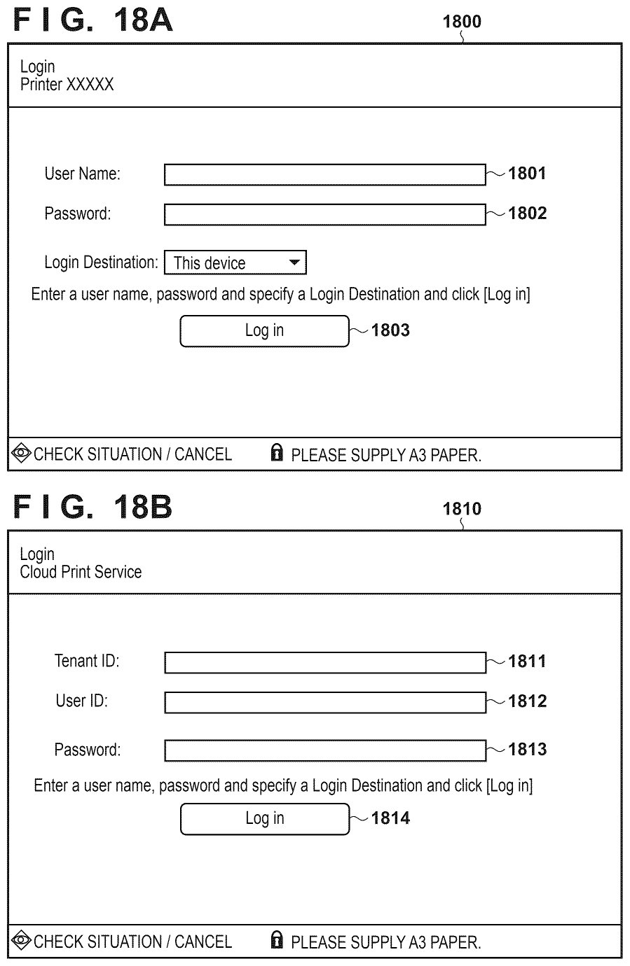

In step S1701, the application platform 340 of the image forming apparatus 103 displays a login screen for the user 900 to log into the image forming apparatus 103 on the operation unit 213. An example of a login screen 1800 will be described with reference to FIG. 18A. The login screen 1800 includes an input field 1801 for inputting a user name and an input field 1802 for inputting a password. The login screen 1800 further includes a login button 1803 for obtaining a login instruction. The user 900 inputs the information requested in the input fields 1801 and 1802 and presses the login button 1803.

In step S1702, the application platform 340 obtains the information input into the input fields 1801 and 1802 in response to the login button 1803 being pressed. In step S1703, the application platform 340 authenticates the user 900 by comparing the user name and password obtained in step S1702 and the user name and password registered in the user management module 351. In the example of FIG. 17, authentication of the user 900 is successful.

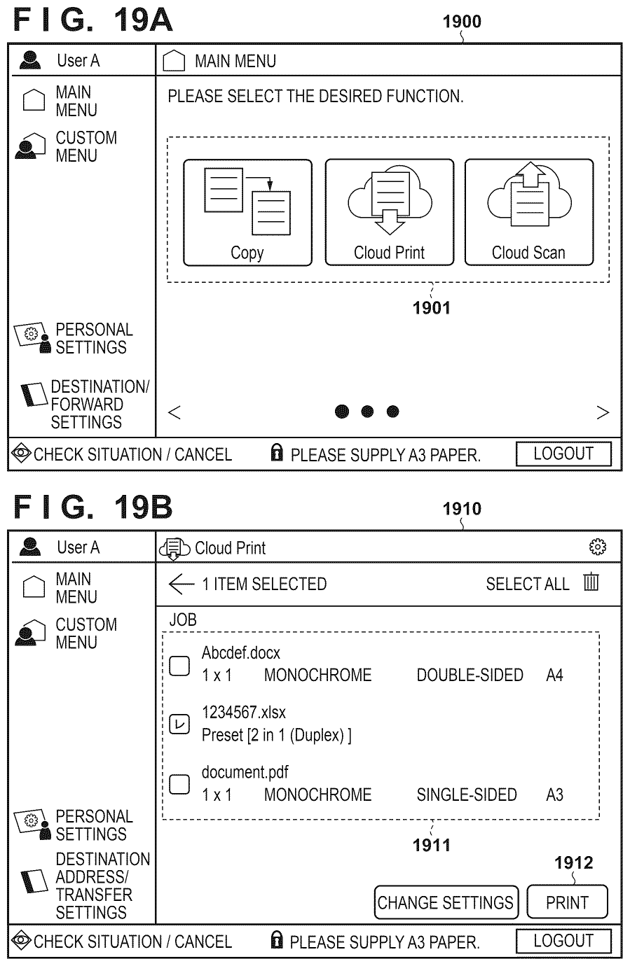

In step S1704, the application platform 340 displays a screen including a list of the applications installed on the image forming apparatus 103 on the operation unit 213. An example of a list screen 1900 will now be described with reference to FIG. 19A. The list screen 1900 includes a field 1901 displaying a list of the applications installed on the image forming apparatus 103. In the field 1901, each application is indicated by an icon. The application platform 340 determines the applications to include in the field 1901 based on the license of the user 900.

In step S1705, the application platform 340 obtains, from the user 900, a designation of any one of the applications included in the field 1901. In the example described below, “Cloud Print” is designated. In step S1706, the application platform 340 runs the cloud print 333 in response to “Cloud Print” being designated. The cloud print 333 makes a request to the printing server 101 for the screen of the cloud print application. In step S1707, the print application 414 of the printing server 101 transmits an authentication screen for logging into the printing server 101 to the image forming apparatus 103 in response to receiving the request.

An example of an authentication screen 1810 for logging into the cloud printing service will now be described with reference to FIG. 18B. The authentication screen 1810 includes an input field 1811 for inputting a tenant ID, an input field 1812 for inputting a user ID, and an input field 1813 for inputting a password. The authentication screen 1810 further includes a login button 1814 for obtaining a login instruction. The user 900 inputs the information requested in the input fields 1811 and 1813 and presses the login button 1804.

In step S1708, the cloud print 333 obtains the information input into the input fields 1811 to 1813 in response to the login button 1814 being pressed. This information may be referred to as authentication information for use in user authentication. In step S1709, the cloud print 333 transmits an authentication request including the authentication information obtained in step S1708 to the printing server 101.

In step S1710, the authentication management 413 of the printing server 101 verifies the authentication information received in step S1709. In the example of FIG. 17, it is assumed that the verification is successful. In step S1711, the print application 414 transmits to the image forming apparatus 103 a screen including a list of the print jobs held in the printing server 101 which are print jobs previously generated according to printing instruction by the authenticated user 900. The screen including a list of the print jobs held in the printing server 101 is represented by a job list screen. In step S1712, the cloud print 333 displays the job list screen received in step S1711 on the operation unit 213.

An example of a job list screen 1910 will now be described with reference to FIG. 19B. The job list screen 1910 includes a field 1911 displaying a list of the print jobs held in the printing server 101 which are print jobs previously generated according to printing instruction by the authenticated user 900. The field 1911 can obtain one or more of the displayed print jobs as a selection from the user 900. The job list screen 1910 further includes a print button 1912 for receiving an instruction to print the selected print job. In the example described below, a print job with the file name “1234567.xlsx” is selected by the user 900 and the print button 1912 is pressed.

In step S1713, the cloud print 333 obtains the selection of the print job in the field 1911 in response to the print button 1912 being pressed. In step S1714, the cloud print 333 makes a request to the printing server 101 for the print data of the print job selected by the user 900. The cloud print 333 may include information for identifying the image forming apparatus 103 such as the serial number of the image forming apparatus 103 in the request. For example, in a case where the image forming apparatus 103 being operated by the user 900 is “Printer B” of the registered printer list 1106, the serial number “BBB00001” is included in the request.

In step S1715, the print application 414 of the printing server 101 identifies the data format of the print data to be transmitted to the image forming apparatus 103 in response to the request being received in step S1714. First, the print application 414 identifies the device information of the image forming apparatus 103 that transmitted the request by referencing the database 424. Thereafter, the print application 414 identifies the data format that can be printed by the image forming apparatus 103 based on the identified device information. As described above with reference to FIG. 8B, the data format printable by the image forming apparatus 103 with the serial number “BBB00001” is “LIPSLX”.

In a case where there are a plurality of data formats printable by the image forming apparatus 103, the print application 414 selects one of the plurality of data formats using any method. For example, a priority order may be set in advance for the plurality of data formats, and the print application 414 may select the data format with the highest priority order from among the plurality of data formats printable by the image forming apparatus 103. Alternatively, the print application 414 may select one data format from among the plurality of data formats printable by the image forming apparatus 103 randomly or via round robin. Alternatively, in a case where there are a plurality of data formats printable by the image forming apparatus 103, the print application 414 may identify all of the printable data formats as the data format of the print data to be transmitted to the image forming apparatus 103.

In step S1716, the print application 414 transmits the print data held in the storage 423 that has already been converted into the data format identified in step S1715 and that has been requested by the image forming apparatus 103 to the image forming apparatus 103. In a case where a plurality of data formats are identified in step S1715, for each data format, the print application 414 transmits print data converted into each data format to the image forming apparatus 103.

In step S1717, the cloud print 333 prints the print data received in step S1716. In a case where the print data converted into each data format in step S1716 is received, the cloud print 333 prints the print data in one of the data formats.

As described above, according to the present embodiment, the printing server 101 identifies the data format for conversion of the print data based on the device information of the one or more image forming apparatuses 103. Thus, the print data is converted into a format that is printable by the image forming apparatus executing the printing. Specifically, in a case where the print data is obtained from the user, the print data is converted into a data format printable by the image forming apparatus with a high possibility of being used by the user to execute printing. As a result, the processing time when the user executes printing with the image forming apparatus 103 can be reduced. Also, by converting the print data into only data formats that are printable by the image forming apparatus of the tenant that the user belongs to, the processing load of the printing server 101 and the used storage capacity can be reduced.

In the embodiment described above, the printing server 101 converts the print data into one or more data formats irrespective of whether or not there is a request for print data from the one or more image forming apparatuses 103 included in the printing system 100. Specifically, the printing server 101 converts the print data in response to the print data being obtained from the information processing terminal 104 (for example, after this). Alternatively, the printing server 101 may convert the print data in response to a different condition being satisfied. For example, in step S1710 of FIG. 17, the printing server 101 may convert the print data in response to the user 900 logged into the image forming apparatus 103 being authenticated. In this case, the print data may be converted to one or more data formats printable by the image forming apparatus 103 based on the device information of the image forming apparatus 103 that transmitted the authentication request in step S1709.

In the embodiment described above, in step S1602 of FIG. 16, the printing server 101 identifies the image forming apparatus 103 registered in the tenant that the user belongs to. Alternatively, the printing server 101 may not execute step S1602. In this case, in step S1603, the printing server 101 may identify at least one data format printable by the one or more image forming apparatuses 103 registered in the printing server 101.

### SECOND EMBODIMENT

The printing system 100 according to the second embodiment will now be described. Here, similarities with the first embodiment will be omitted, and only differences with the first embodiment will be described.

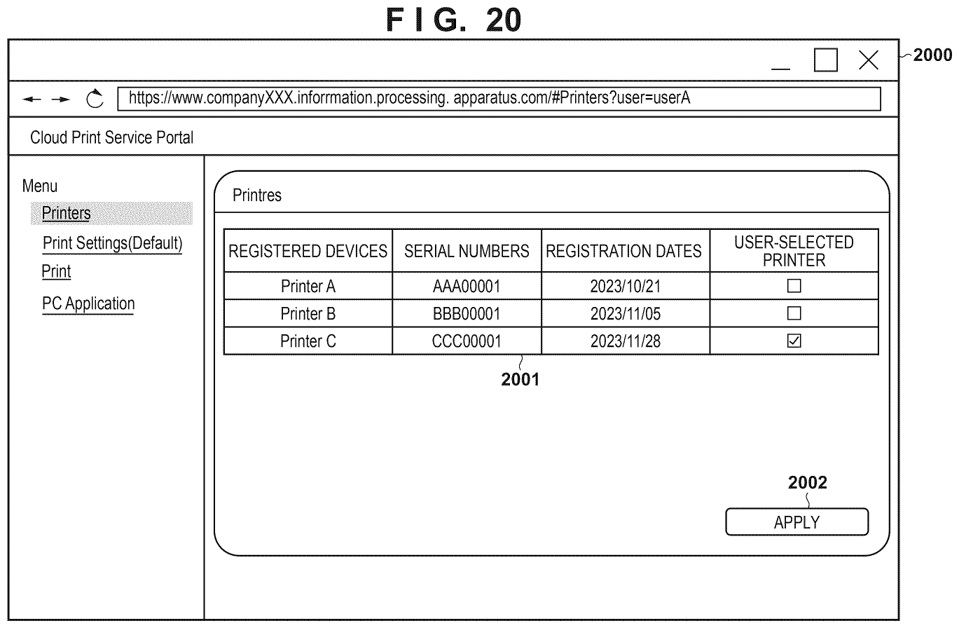

In the second embodiment, instead of the portal screen 1100 of FIG. 11, a portal screen 2000 of FIG. 20 is used. The portal screen 2000 is different from the portal screen 1100 in that it includes a registered printer list 2001 instead of the registered printer list 1106 and further includes an apply button 2002. The registered printer list 2001 is different from the registered printer list 1106 in that it includes a column for obtaining a designation of image forming apparatuses with a possibility of being used by the user.

The user 900 authenticated by the printing server 101 in step S907 can use this column to designate the image forming apparatus 103 with a possibility of being used by the user 900 from among the one or more image forming apparatuses 103 registered in the tenant that the user 900 belongs to. The web page display unit 520 of the information processing terminal 104 transmits the setting of the registered printer list 2001 together with the user ID of the user 900 to the printing server 101 in response to the apply button 2002 being pressed by the user 900.

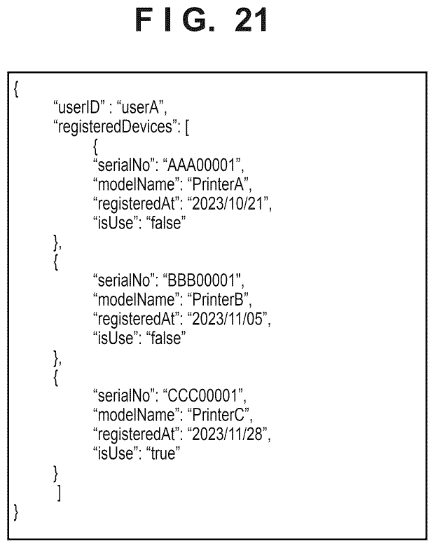

The printing server 101 stores the setting transmitted from the information processing terminal 104 in association with the user. FIG. 21 illustrates the format of the data stored in the database 424 for storing the setting. “UserID” represents an identifier of the user. “registeredDevices” represents the information of the one or more image forming apparatuses 103 registered in the tenant that the user belongs to. “isUse” represents whether or not the user is set to use each image forming apparatus 103. In a case where “isUse” is “false”, this represents that the user is set to not use the image forming apparatus 103. In a case where “isUse” is “true”, this represents that the user is set to use the image forming apparatus 103. In the example of FIG. 21, only the image forming apparatus 103 with the serial number “CCC00001” is set for use. The printing server 101 manages the one or more image forming apparatuses 103 associated with each of the users set in this manner.

In the second embodiment, in step S1603 of FIG. 16, the print application 414 identifies the data format printable by at least one of the image forming apparatuses 103 based on the device information of the one or more image forming apparatuses 103 associated with the user who designated the data to be printed from among the one or more image forming apparatuses 103 identified in step S1602. For example, in the example described above, since only the image forming apparatus 103 with the serial number “CCC00001” is set for use, only the “JPEG” format is identified by referencing FIG. 8C.

As described above, by converting the print data into only data formats that are printable by the image forming apparatus set for use by the user, the processing load of the printing server 101 and the used storage capacity can be reduced.

### Modified Example

A modified example of the first embodiment and the second embodiment described above will be described below. Similarities with the embodiments described above will be omitted, and only differences will be described.

In a case where the number of the image forming apparatuses 103 registered in the printing server 101 increases or decreases in a state with the printing server 101 holding print data, the image forming apparatuses 103 with a possibility of being used by the user may change. Here, in the modified example, according to the change, the data format of the print data may be further converted or the converted print data may be deleted.

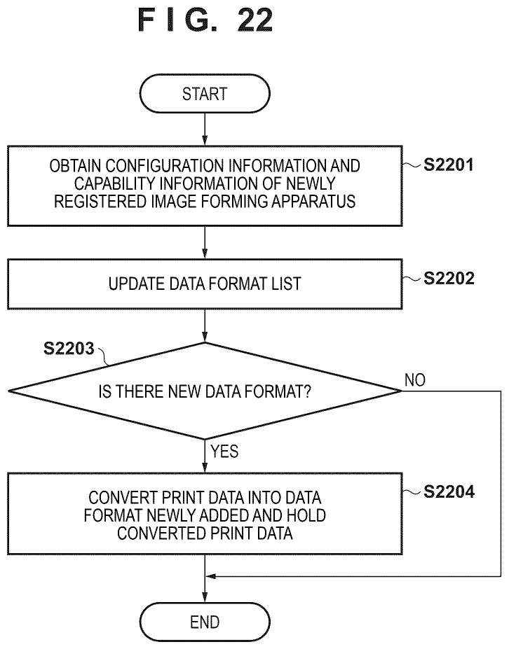

First, a method executed by the printing server 101 based on the image forming apparatus 103 being newly registered in the printing server 101 while print data of one or more data formats is held will now be described with reference to FIG. 22. The processing of the printing server 101 is implemented by a program stored in the ROM 222 being read out to the RAM 223 and executed by the CPU 221.

In step S2201, the print application 414 of the printing server 101 obtains device information (for example, configuration information and capability information) of the newly registered image forming apparatus 103 from the database 424.

In step S2202, the print application 414 updates the data format list based on the device information of the newly registered image forming apparatus 103 for each held piece of print data. As described above, the data format list is a list of data formats printable by at least one of the one or more image forming apparatuses 103.

In step S2203, the print application 414 determines whether or not the updated data format list includes the new data format. In a case where the print application 414 determines that the updated data format list includes the new data format (YES in step S2203), the processing transitions to step S2204. Otherwise (NO in step S2203), in the processing ends.

In step S2204, the print application 414 further converts the print data into the data format newly added by updating the data format list and holds the converted print data. Accordingly, even in a case where the user uses the image forming apparatus 103 registered after the converted print data is held, the data format of the print data can be converted before the print data is requested.

Next, a case in which the registration of one of the one or more image forming apparatuses 103 registered in the printing server 101 is removed while the print data of one or more data formats is held will be described.

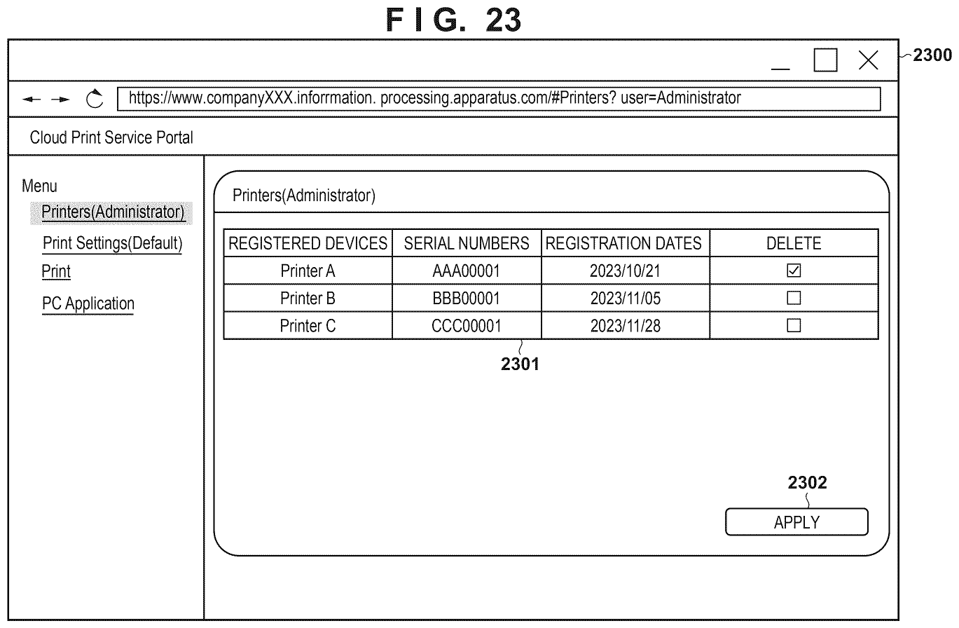

For such processing, a portal screen 2300 of FIG. 23 is used instead of the portal screen 1100 of FIG. 11. The portal screen 2300 may be displayed when the administrator of the device logs in. The portal screen 2300 is different from the portal screen 1100 in that it includes a registered printer list 2301 instead of the registered printer list 1106 and further includes an apply button 2302. The registered printer list 2301 is different from the registered printer list 1106 in that it includes a column for obtaining a designation of the image forming apparatus for registration removal.

The user (administrator) can use the column to designate the image forming apparatus 103 for registration removal from among the one or more image forming apparatuses 103 registered in the tenant that the user manages. The web page display unit 520 of the information processing terminal 104 transmits the identifier of the image forming apparatus 103 for registration removal to the printing server 101 in response to the apply button 2302 being pressed by the user.

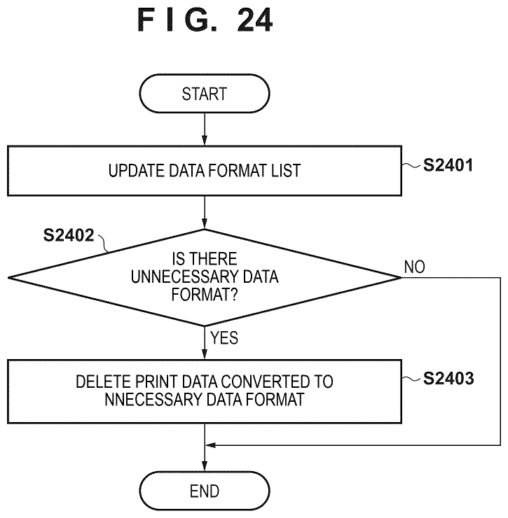

Now, a method executed by the printing server 101 based on removing the registration of one of the one or more image forming apparatuses 103 registered in the printing server 101 while the print data of one or more data formats is held will be described with reference to FIG. 24. The processing of the printing server 101 is implemented by a program stored in the ROM 222 being read out to the RAM 223 and executed by the CPU 221.

In step S2401, the print application 414 updates the data format list based on the device information of the currently registered image forming apparatus 103 for each held piece of print data. Since the registration of one of the image forming apparatuses 103 is removed, a change may occur in the data formats.

In step S2402, the print application 414 determines whether or not there is a data format that has been made unnecessary by the update of the data format list. In a case where the print application 414 determines that there is an unnecessary data format (YES in step S2402), the processing transitions to step S2403. Otherwise (NO in step S2402), the processing ends.

In step S2403, the print application 414 stops holding the print data converted to an unnecessary data format. Specifically, the print application 414 may delete the print data stored in the storage 423. In this manner, since, after the converted print data is held, the print data of a data format with no possibility of being used is not held, the used storage capacity can be reduced.

Also, in a case where the designation of an image forming apparatus with a possibility of being used by the user is changed in the registered printer list 2001 of the second embodiment, the data format list may be updated as in the modified example described above. In the modified example described above, instead of executing steps S2204 and S2403 in response to the data format list being updated, steps S2204 and S2403 may be executed in a case where a different condition is satisfied. For example, steps S2204 and S2403 may be executed in response to one of either step S1709, step S1711, or step S1714 in FIG. 17 being executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074041, filed Apr. 30, 2024, which is hereby incorporated by reference herein in its entirety.

What is claimed is:

1. A printing system comprising a server and one or more image forming apparatuses, wherein
the server includes
an obtaining unit configured to obtain, from an information processing apparatus, data to be printed,
an identifying unit configured to identify one or more formats based on device information of the one or more image forming apparatuses,
a converting unit configured to convert the data into the one or more formats, and
a holding unit configured to hold the data converted into the one or more formats, and
at least one image forming apparatus of the one or more image forming apparatuses includes
a receiving unit configured to receive, from the server, the data of at least one format from among the data of the one or more formats held by the server, and
a printing unit configured to print the received data.

2. The printing system according to claim 1, wherein the converting unit converts the data into the one or more formats irrespective of whether or not the data is requested by the one or more image forming apparatuses.

3. The printing system according to claim 1, wherein the identifying unit identifies the one or more formats based on device information of one or more image forming apparatuses registered in a tenant that a user who designated the data as a print target belongs to from among the one or more image forming apparatuses.

4. The printing system according to claim 1, wherein the identifying unit identifies the one or more formats based on device information of one or more image forming apparatuses associated with a user who designated the data as a print target from among the one or more image forming apparatuses.

5. The printing system according to claim 4, wherein the server further includes a unit configured to manage one or more image forming apparatuses associated with each one of a plurality of users.

6. The printing system according to claim 1, wherein the server further includes a unit configured to, based on the data being requested by one image forming apparatus of the one or more image forming apparatuses, identify one or more formats printable by the one image forming apparatuses from among the one or more formats.

7. The printing system according to claim 1, wherein
the one or more image forming apparatuses are registered in the server,
the identifying unit updates the one or more formats based on a new image forming apparatus being registered in the server while the data of the one or more formats is held,
the converting unit further converts the data into a format newly added by an update of the one or more formats, and
the holding unit further holds the data of the format newly added.

8. The printing system according to claim 1, wherein
the one or more image forming apparatuses are registered in the server,
the identifying unit updates the one or more formats based on registration of one of the one or more image forming apparatuses being removed while the data of the one or more formats is held, and
the holding unit stops holding the data of a format made unnecessary by an update of the one or more formats.

9. A non-transitory computer-readable storage medium that stores a program for causing one or more computers to function as the printing system according to claim 1.

10. A printing method performed by a printing system including a server and one or more image forming apparatuses, the method comprising:
obtaining, by the server from an information processing apparatus, data to be printed;
identifying, by the server, one or more formats based on device information of the one or more image forming apparatuses;
converting, by the server, the data into the one or more formats;
holding, by the server, the data converted into the one or more formats;
receiving, by one image forming apparatus of the one or more image forming apparatuses from the server, the data of at least one format from among the data of the one or more formats held by the server; and
printing, by the one image forming apparatus, the received data.

11. A server system, comprising:
an obtaining unit configured to obtain, from an information processing apparatus, data to be printed;
an identifying unit configured to identify one or more formats based on device information of one or more image forming apparatuses registered in the server system;
a converting unit configured to convert the data into the one or more formats;
a holding unit configured to hold the data converted into the one or more formats; and
a transmitting unit configured to transmit the data of at least format from among the data of the one or more formats to an image forming apparatus.
